(19) United States
(12) Patent Application Publication
(10) Pub. No.: US 2005/0256648 A1
(43) Pub. Date: Nov. 17, 2005

(54) Velocity determination of the near-surface layers in the earth using exploration 2D or 3D seismic data

(76) Inventor: Michael Patrick West, Calgary (CA)

Correspondence Address: MICHAEL PATRICK WEST, 3715 BROOKLYN CRESCENT, NW, CALGARY, AB, T2L-1G9, CA

(21) Appl. No.: 11/111,907

(22) Filed: Apr. 22, 2005

Related U.S. Application Data
(60) Provisional application No. 60/569,523, filed on May 11, 2004.

(51) Int. Cl. G01V 1/00

(52) U.S. Cl. 702/16

(57) ABSTRACT

Several methods for determining the near-surface layer velocity in the earth (can include the weathering layer velocity) from exploration seismic 2D or 3D data are presented. These velocity measurements are to be used in time-correcting seismic data during data processing in refraction statics, datum statics, elevation statics derivation and application or any other data processing scheme wherein the near-surface velocity is required. They can also be used as the near-surface velocity model for depth-migration of seismic data. The velocity of the near-surface is directly related to the character of the shot records themselves. By statistically measuring this character from the shot records in an automated fashion, a large amount of data can be processed and the character measurement numerically converted to a velocity measurement using benchmark velocities. A complete near-surface velocity field for the seismic survey can be created in this way and used to correct for false time-structure in seismic datasets used for hydrocarbon exploration or any other sub-surface exploration purposes.

This application claims the benefits of the previous provisional application No. 60/569,523 with filing date May 11, 2004.

### BACKGROUND OF INVENTION

It is well-known that false time-structure (static-correction errors) can exist on most land, shallow marine (and even conventional marine) seismic 2D and 3D data. This is due to the fact that large lateral velocity variations exist in the near-surface layers of the earth which cause travel-time errors which distort the reflection-time image of the subsurface reflectors below. Refraction statics and statics created from Tomographic models can reduce the problem to some degree but both methods suffer from the lack of velocity information in this near-surface layer. Velocity information is sometimes incorporated from drilled “uphole” survey information, but this information is usually on the order of 1 or 2 kilometers spatial intervals at best which is not small enough spatial sampling to eliminate static correction errors. Depth migrated data can also suffer from an inaccurate velocity model of the near-surface layers.

The false time or depth structures left in the processed 2D or 3D seismic sections can lead to misinterpretation of hydrocarbon prospects and possibly to costly errors in oil and gas well placement sometimes costing millions of dollars.

For seismic data, the attenuation coefficient is related to the frequency content of seismic data and the velocity of the medium by:

$$∝ = \frac{\prod f}{Qv}$$

where
:∝ is the attenuation coefficient
:f is the frequency
:v is the velocity of the medium
:1/Q is the specific dissipation constant

It is known empirically that 1/Q is related to velocity by:

$$\frac{1}{Q} \approx \frac{{10}^{6}}{{v}^{2}} ( Waters , 1981 )$$

Therefore as seismic velocity decreases, the attenuation of high frequencies increases dramatically.

These axioms would be confirmed by any geophysicist who has perused many raw field seismic records. Wherever the sources and receivers are in or on top of a layer of very low velocity material (600 m/sec. silt lense for example) the records are very “boomy” with low dominant frequency. When the sources and receivers are in or on top of a relatively higher velocity layer, the dominant frequency of the records is much higher and all events are crisper.

By systematically measuring the dominant frequency of the seismic traces near the source points, we can achieve a relative measurement of the near-surface velocity. By incorporating an in-situ velocity measurement from drilled uphole recording locations (preferable in both areas of fast and slow near-surface velocity) the velocity field can be calibrated to a close estimate of the actual velocity field.

### REFERENCES

Waters, K. H. (1981), Reflection Seismology, a Tool for Energy Resource Exploration, John Wiley and Sons, New York

### SUMMARY OF INVENTION

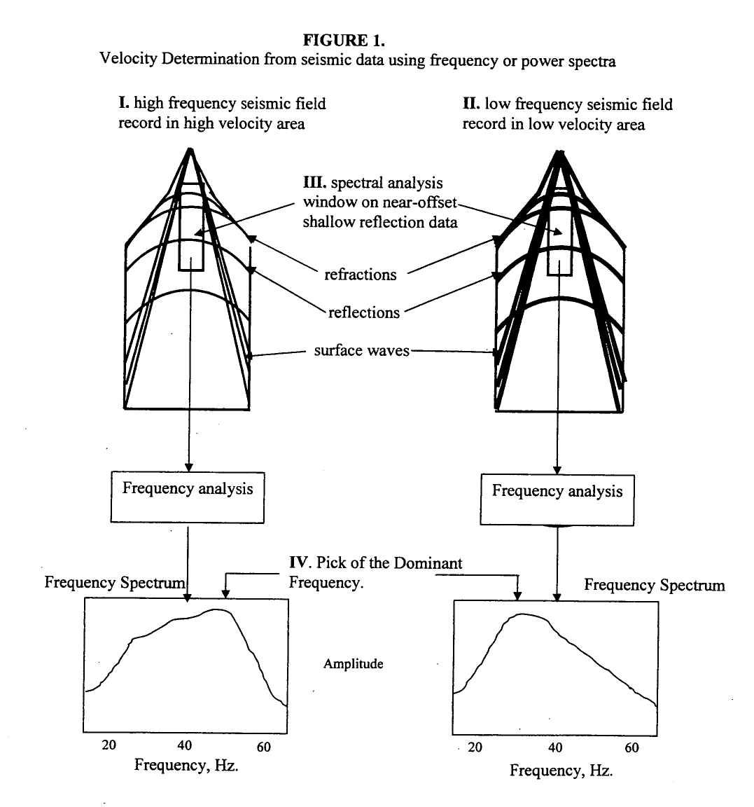

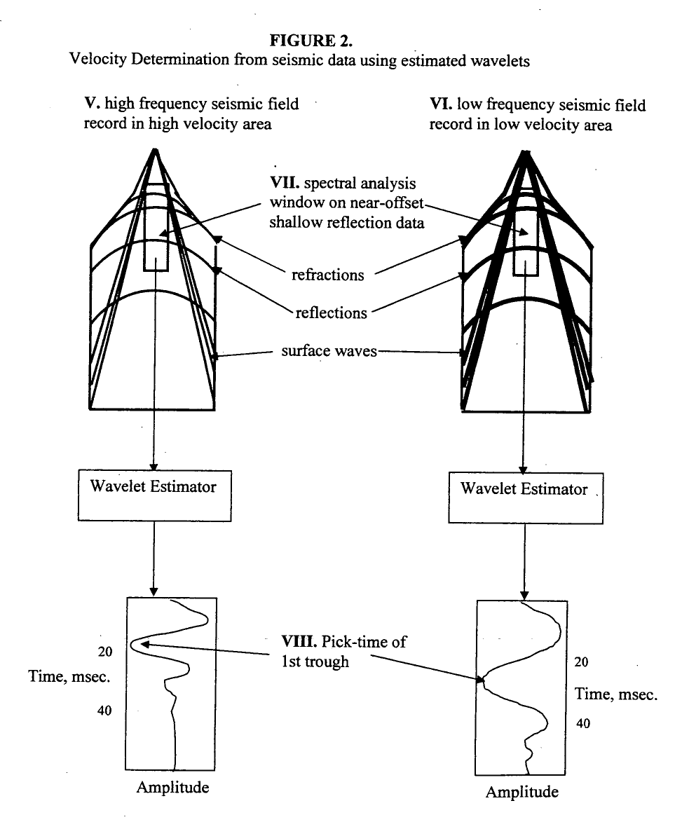

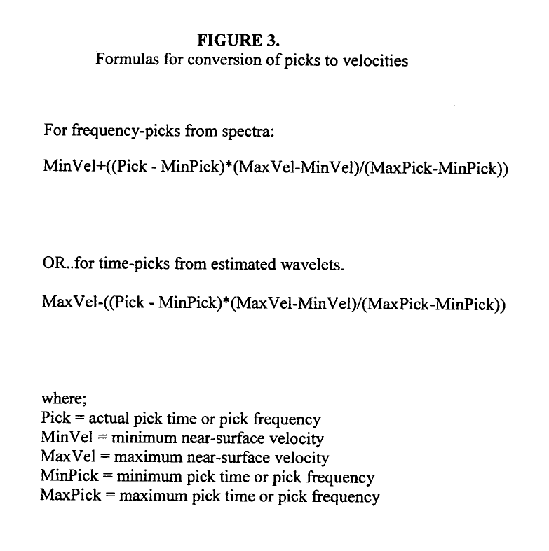

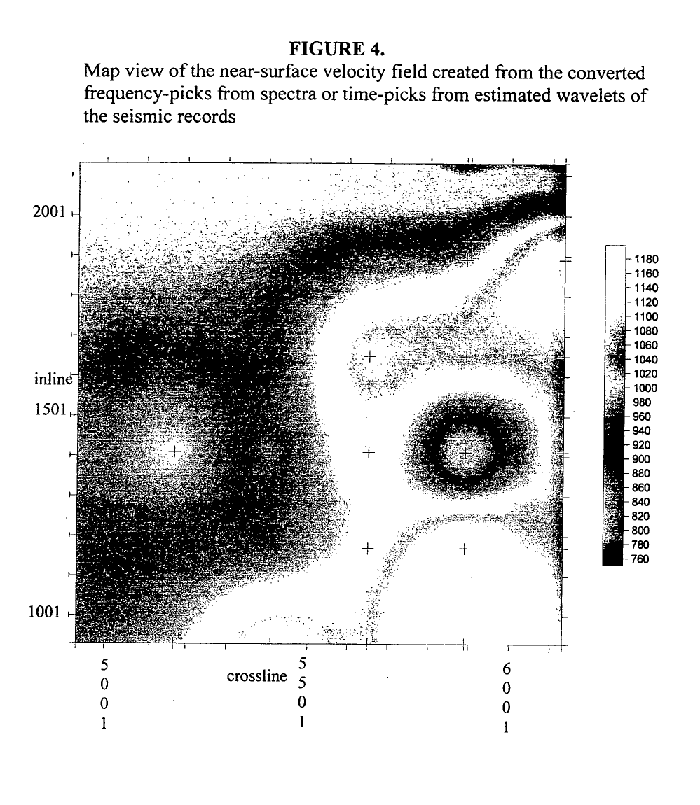

Using commercially available seismic data processing software, every source record in the 2D or 3D field survey can be analyzed for frequency content or estimated wavelets and picked using an automated picker as shown in FIGS. 1 and 2. The pick dataset can be processed through the conversion to a velocity field using a programming language or “spreadsheet” manipulations and the formulas in FIG. 3. The associated velocity field which yields a near-surface velocity value for each source-point on the survey, (FIG. 4) can be then used to create a static-time correction to a flat or floating datum which incorporates the surface elevation and near-surface velocity for each surface station. It can also be used in a refraction statics solution or depth-imaging procedure or any other seismic data processing procedure that will benefit from an accurate model of the near-surface velocity variations.

### DETAILED DESCRIPTION OF INVENTION

It is the intention of this invention to provide an estimate of the near-surface velocity variations and therefore a velocity field that can be used in any time-correction or depth-correction method to alleviate the problems outlined above.

Near-surface velocity estimation using frequency spectra
estimate the frequency content of unprocessed field records for a given analysis window (FIG. 1, element III.) using either averaged frequency spectra or averaged power spectra
make a relative measure or “pick” of the dominant frequency peak of the spectrum or of the power spectrum.(FIG. 1, element IV.)
save and record this dataset of measured “picks” for each surface location
determine an estimated minimum near-surface velocity value and a maximum near-surface velocity value from drilled uphole information or from best-guess estimates or other available information in the area.
associate the minimum dominant frequency pick value with a minimum near-surface velocity value and a maximum dominant frequency pick value with a maximum velocity value
derive a velocity value for each of the “pick” values in the dataset using the formula
   for pick “frequency” (higher frequencies indicates higher velocity)
   MinVel+((Pick−MinPick)*(MaxVel−MinVel)/(MaxPick−MinPick))

Near-surface velocity estimation using estimated wavelets
create estimates of the frequency content of unprocessed field records for a given analysis window (FIG. 2, element VII) using estimated wavelets from Fourier Transforms, Hilbert Tranforms or Weiner filtering at each shot record location (FIG. 2, elements V. VI, VII, VIII)
make a relative measure or “pick” of peak-time or trough-time of the first event on the estimated created from the power spectrum or autocorrelations for each field record.(FIGS. 1 and 2)
save and record this dataset of measured “picks” for each surface location
determine an estimated minimum near-surface velocity value and a maximum near-surface velocity value from drilled uphole information or from best-guess estimates or other available information in the area.
associate the minimum time of trough (or peak) pick value of the estimated minimum-phase wavelet with a maximum near-surface velocity value and a maximum time of trough pick value with a minimum velocity value
derive a velocity value for each of the “pick” values in the dataset using the formula
   for pick “time” (larger time indicates lower velocity)
   MaxVel−((Pick−MinPick)*(MaxVel−MinVel)/(MaxPick−MinPick))
   where;
Pick=actual pick time or pick frequency
MinVel=minimum near-surface velocity
MaxVel=maximum near-surface velocity
MinPick=minimum pick time or pick frequency
MaxPick=maximum pick time or pick frequency (see FIG. 3)
   create a near-surface velocity field for every surface station by interpolation of the near-surface velocity field at each source-point location (see FIG. 4).

1. A method for determining the velocity of the near-surface layers in the earth by automated measurement of the character and frequency content of seismic records, for use in the calculation of statics corrections to remove false time structure from 2D and 3D seismic data.

2. A method for determining the velocity of the near-surface layers in the earth by automated measurement of the character and frequency content of seismic records for use in velocity modeling for depth or time migration of 2D or 3D seismic data.

3. A method for determining the velocity of the near-surface layers in the earth by automated measurement of the character and frequency content of seismic records for use in any 2D or 3D seismic data processing scheme wherein the near-surface velocity is required.

4. The method of claims 1, 2 and 3 wherein the method of measuring the frequency content can be by picking the frequency of maximum amplitude (dominant frequency) from a frequency spectrum chart or by picking the first major event time (trough or peak) from an estimated wavelet created from the seismic record using Fourier transforms, Hilbert transforms or Weiner filtering.

5. The method of claims 1, 2 and 3 wherein the method of measuring the frequency content is by picking the first major event time (trough, peak or zero-crossing) from an estimated wavelet created from the seismic record using auto-correlations.
